(19) United States
(12) Patent Application Publication
(10) Pub. No.: US 2004/0219408 A1
(43) Pub. Date: Nov. 4, 2004

(54) Air compression system for a fuel cell arrangement and cold air process-air conditioning unit or heat pump

(76) Inventor: Ullrich Hesse, Affalterbach (DE)

Correspondence Address: Striker Striker & Stenby, 103 East Neck Road, Huntington, NY, 11743, US

(21) Appl. No.: 10/466,217

(22) PCT Filed: Dec. 1, 2001
(86) PCT No.: PCT/DE01/04513

(30) Foreign Application Priority Data
Jan. 16, 2001 (DE) 101 01 914.9

(51) Int. Cl. H01M 8/04

(52) U.S. Cl. 429/26; 429/34

(57) ABSTRACT

The invention relates to an apparatus, in particular for a fuel cell-powered vehicle, with a compressor (6) that compresses air, which constitutes the working medium of a cold air process air conditioning unit or heat pump.

The invention provides that at least part of the air compressed by the compressor (1) is supplied to a fuel cell unit (6).

The invention also relates to the use of a cold air process air conditioning unit or heat pump as a source for compressed air that is supplied to a fuel cell unit, and to the use of a compressor, which supplies compressed air to a fuel cell unit, as a source for compressed air that constitutes or is an ingredient of the working medium of an air conditioning unit.

The current invention relates to an apparatus, in particular for a fuel cell-powered vehicle, with a compressor that compresses air, which constitutes the working medium of a cold air process air conditioning unit or heat pump. The invention also relates to a special use of a cold air process air conditioning unit or heat pump and to a special use of a compressor that supplies compressed air to a fuel cell unit.

The term fuel cell unit here, in addition to referring to the actual fuel cell, can also encompass a reformer that may be present. It is known that fuel cell units, for example for fuel cell-powered vehicles, require an air compressor or a compressor in order to operate the fuel cell unit (including the fuel reformer that may be provided), which compresses the air required for the process occurring inside the fuel cell unit, taking it from atmospheric pressure, which can be 1 bar, for example, and compressing it to a higher pressure, for example to 2 bar or more. In this connection, it is known, for example, to use piston, scroll, or turbo compressors, in which electric motors are used to drive the compressor. It is possible to recover part of the exerted compressor work by means of an expander or an expansion machine disposed in the exhaust line of the fuel cell unit. In this case, the compressor, the electric motor that drives the compressor, and the expander can be disposed, for example, on a common shaft. Due to the incompatibility of lubricating oil with the fuel cell process and the reforming process that is possibly provided, as a rule oil-free compressors and expanders are used.

In connection with fuel cell-powered vehicles, it is also known to equip such vehicles with air conditioning units that operate based on a cold vapor compression process. The compressors of such air conditioning units can, for example, be embodied as hermetic compressors in which the compressor and the electric drive motor of the compressor are accommodated in a common housing, without a shaft feedthrough.

There are also cold air process air conditioning units known from the air conditioning field in which air is the working medium for the cooling process. A known cold air process air conditioning unit of this kind is shown in FIG. 1. The cold air process air conditioning unit according to FIG. 1 has a compressor 1, which is driven by an electric motor 2. The compressor 1 takes in air from the surroundings or from a particular chamber and compresses it, in the process of which this air is heated. The heated and compressed air is then supplied to a heat exchanger 5, where the compressed air has thermal energy drawn from it, which in the instance shown, is imparted to air that can come, for example, from a passenger compartment 4. After the compressed air has passed through the heat exchanger 5, it is supplied to an expander 3, where the temperature of the air drops as a result of the expansion process. The air, which has a lower temperature (than the air taken in by the compressor 1), can then be supplied, for example, to a passenger compartment 4. The expander 3 can recover part of the compressor work, which is why the expansion machine or expander 3, the electric motor 2, and the compressor 1 are disposed on a common shaft, according to the depiction in FIG. 1.

It follows from this that fuel cell-powered vehicles according to the prior art, for example equipped with an air conditioning unit, have two compressors with two drive units, which undesirably increases the weight of the vehicle, for example.

### ADVANTAGES OF THE INVENTION

Since the apparatus according to the invention includes the feature that at least part of the air compressed by the compressor is supplied to a fuel cell unit, the apparatus only requires a single compressor, which permits the weight of the apparatus, for example, and/or its overall cost to be reduced. This turns out to be extremely positive, for example, in fuel cell-powered vehicles.

In the apparatus according to the invention, the cold air process air conditioning unit preferably has a first heat exchanger, which is supplied with the portion of the air compressed by the compressor that is not supplied to the fuel cell unit. The first heat exchanger serves to draw thermal energy out of the compressed air. This thermal energy can, for example, be imparted to an air flow that is conveyed through the first heat exchanger. Naturally, the thermal energy can also be imparted to other media. In this connection, for example, intrinsically known circuits for cold air process air conditioning or cold air process heat pump processes can be used in which one or more compressor stages and one or more expansion stages or expanders can be provided.

In the apparatus according to the invention, the compressed air supplied to the fuel cell unit preferably has a pressure of more than 1.5 bar, for example a pressure of 2 bar. In many cases, a pressure level of 2 bar is suitable for operating intrinsically known fuel cell units.

Preferably, the apparatus according to the invention also includes the feature that compressed air coming out of the first heat exchanger is supplied to a first expander. The expansion of the air causes its temperature to drop, as a rule producing temperature values considerably lower than the temperature of the air taken in by the compressor.

Particularly when the compressed air or compressed exhaust comes out of the fuel cell unit at a high temperature, it is possible for the fuel cell unit to be followed by a second heat exchanger that cools the compressed air or compressed exhaust coming out of the fuel cell unit.

In addition or alternatively, the apparatus according to the invention can include the feature that compressed air or compressed exhaust coming out of the fuel cell unit (possibly via the second heat exchanger) can be supplied to a second expander. This can be useful particularly if air coming out of the first expander is to be used to cool a passenger compartment, for example, and it is undesirable for the air or exhaust coming out of the fuel cell unit to mix with the air used for the cooling.

The air coming out of the first expander at a lower temperature can, as mentioned above, be supplied to the interior of a vehicle, for example, for the purpose of cooling it.

In this connection, the apparatus according to the invention can also include the feature that the air coming out of the first expander is supplied to a third heat exchanger. This third heat exchanger can, for example, be provided in order to reduce the temperature of air used for cooling. This embodiment can be used particularly when compressed air or compressed exhaust coming out of the fuel cell unit and compressed air coming out of the first heat exchanger are supplied to the same (first) expander and it is undesirable for air or exhaust coming out of the fuel cell unit to be used directly as cooling air.

As mentioned above, the first heat exchanger draws thermal energy out of the compressed air.

To this end, the first heat exchanger is preferably supplied with a medium to which the thermal energy of the compressed air is imparted; the medium supplied to the first heat exchanger can, for example, be air from a chamber cooled by the cold air process air conditioning unit, for example the vehicle interior mentioned above. But during heat pump operation, heat is taken from the surroundings and the vehicle interior, for example, is heated.

The compressor is preferably driven by an electric machine in the form of an electric motor.

In order to improve the efficiency, it is also possible for the first expander and/or the second expander or the expansion machine to recover part of the compression work.

In order to supply the compression work recovered by the first expander and/or the second expander back into the system, the apparatus according to the invention can include the feature that the compressor, the electric motor that drives the compressor, and the first expander and/or the second expander can be connected in a positively engaging manner.

To this end, the compressor, the electric motor that drives the compressor, and the first expander and/or the second expander are preferably disposed on a common shaft or are disposed on shafts that are coupled to one another by means of transmission mechanisms.

In the apparatus according to the invention, the capacity of the compressor and/or of the electric motor that drives the compressor can be designed in such a way that it corresponds to the peak capacity required by the fuel cell unit. In this case, by dispensing with air conditioning during the relatively infrequent peak capacity instances of the fuel cell unit, it is possible in many cases to use a compressor whose capacity corresponds approximately to the capacity that is usually provided anyway in compressors that supply fuel cell units.

The scope of the associated claims includes any use of a cold air process air conditioning unit or heat pump as a source for compressed air that is supplied to a fuel cell unit.

Similarly, the scope of the associated claims includes any use of a compressor, which supplies compressed air to a fuel cell unit, as a source for compressed air that constitutes or is an ingredient of the working medium of an air conditioning unit or heat pump.

The current invention makes it possible to produce, for example, a fuel cell-powered vehicle that has an air conditioning unit and an air compressor, which in comparison to the prior art, has approximately the same efficiency, but whose overall vehicle weight and costs can be reduced. Depending on the design of the apparatus, synergy and concurrency effects permit the capacity of the compressor used to be less than the sum of the capacities of the two compressors used according to the prior art.

### DRAWINGS

The invention will be explained in more detail below in conjunction with the accompanying drawings.

FIG. 1 shows a cold air process air conditioning unit according to the prior art,

FIG. 2 shows a first embodiment of the apparatus according to the invention,

FIG. 3 shows a second embodiment of the apparatus according to the invention, which prevents a mixture of the fuel cell unit exhaust and the cooling air,

FIG. 4 shows a third embodiment of the apparatus according to the invention, in which a cooler is provided for air or exhaust coming out of the fuel cell unit, and

FIG. 5 shows a fourth embodiment of the apparatus according to the invention, which essentially corresponds to the third embodiment, but is also equipped with a heat exchanger to make use of the cold air.

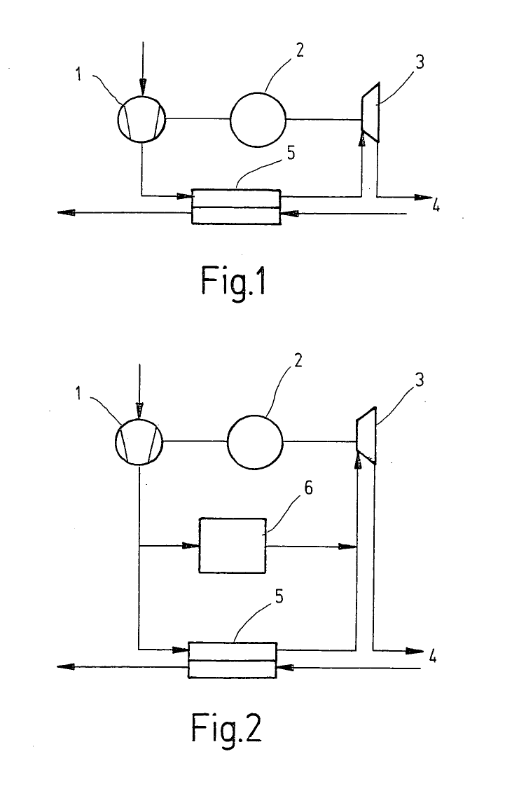

### DESCRIPTION OF THE EXEMPLARY EMBODIMENT

FIG. 2 shows a first embodiment of the apparatus according to the invention, in which only a single compressor 1 is provided, which is driven by an electric motor 2. The compressor 1 takes in ambient air and compresses it, as a result of which the compressed air coming out of the compressor 1 has a higher temperature than the air going into it. Part of the air compressed by the compressor 1 is supplied to a first heat exchanger 5, which is a component of a cold air process air conditioning unit. The first heat exchanger 5 draws thermal energy out of the compressed air flowing through it by imparting this thermal energy to air that in the example shown, comes from a passenger compartment 4. The portion of the air compressed by the compressor 1 that is not supplied to the first heat exchanger 5 is supplied to a fuel cell unit 6 in order to permit the fuel cell unit 6 to operate. In the embodiment according to FIG. 2, both the air coming out of the first heat exchanger 5 and the air coming out of the fuel cell unit 6 are supplied to a first expander 3. The expansion of the air causes its temperature to drop so that the air flowing out of the first expander 3 can be used, for example, to cool a passenger compartment 4. The first expander 3 is also suitable for recovering part of the compressor work and conveying this recovered energy back into the drive system of the compressor 1. To this end, the first expander 3 or the expansion machine 3, the electric motor 2, and the compressor 1 are disposed on a common shaft.

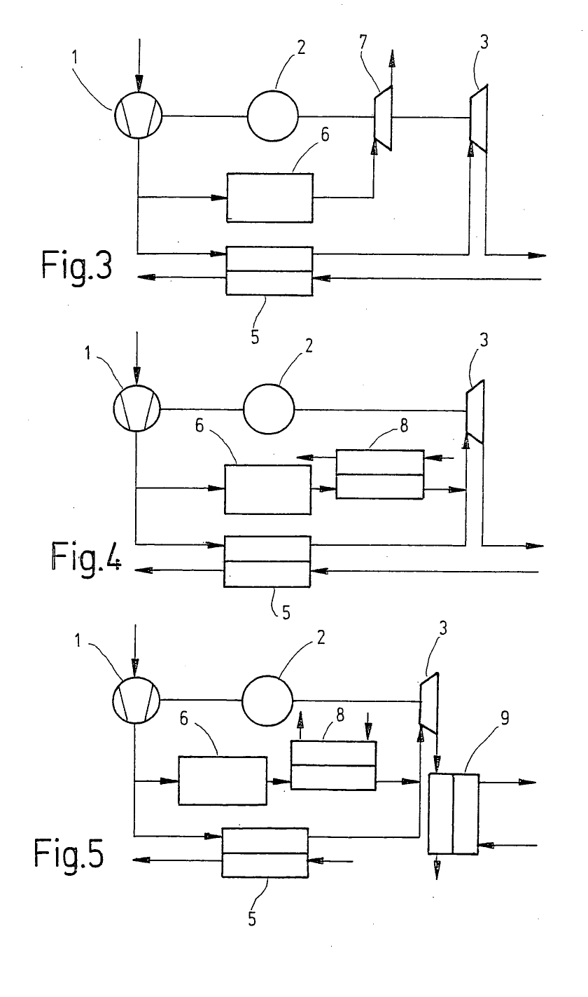

FIG. 3 shows a second embodiment of the apparatus according to the invention, which prevents the air or exhaust coming out of the fuel cell unit 6 from mixing with the cold air provided for the cooling unit. To this end, a second expander 7 is provided, which is supplied with the compressed air or compressed exhaust coming out of the fuel cell unit 6. The second expander 7 is also suitable for recovering part of the compression work and conveying this recovered energy back into the drive system of the compressor 1. To this end, the second expander 7 is disposed on the same shaft as the compressor 1, the electric motor 2, and the first expander 3.

FIG. 4 shows a third embodiment of the apparatus according to the invention, which essentially corresponds to the first embodiment according to FIG. 2. In the third embodiment of the apparatus according to the invention shown in FIG. 4, the fuel cell unit 6 is followed by a second heat exchanger 8. The second heat exchanger 8 serves to cool the compressed air or compressed exhaust coming out of the fuel cell unit 6 before it is supplied to the first expander 3.

FIG. 5 shows a fourth embodiment of the apparatus according to the invention, which is based on the third embodiment shown in FIG. 4. By contrast with the embodiment according to FIG. 4, the fourth embodiment of the apparatus according to the invention shown in FIG. 5 has a third heat exchanger 9, which follows the first expander 3. In this embodiment, the air coming out of the first heat exchanger 5 does in fact mix with the air or exhaust coming out of the fuel cell unit 6, but the mixed air coming out of the first expander 3 is not supplied directly to the passenger compartment. Instead, the cold air coming out of the first expander 3 is used in the third heat exchanger 9 to reduce the temperature, for example, of air provided to cool the interior of the vehicle.

For one skilled in the art, it is clear that the embodiments of the current invention depicted in FIGS. 2 to 5 can be combined in suitable ways.

The current invention is not limited to use with fuel cell-powered vehicles, but can be used wherever both a fuel cell unit and an air conditioner unit are provided, for example for supplying energy and cooling to buildings.

The foregoing description of exemplary embodiments according to the current invention is intended solely for illustrative purposes and is not intended to limit the invention. Various changes and modifications are possible without going beyond the scope of the invention and its equivalents.

1. An apparatus, in particular for a fuel cell-powered vehicle, with a compressor (6), which compresses air that constitutes the working medium of a cold air process air conditioning unit or heat pump, characterized in that at least part of the air compressed by the compressor (1) is supplied to a fuel cell unit (6).

2. The apparatus according to claim 1, characterized in that the cold air process air conditioning unit has a first heat exchanger (5), which is supplied with the portion of air compressed by the compressor (6) that is not supplied to the fuel cell unit (6).

3. The apparatus according to claim 1 or 2, characterized in that the fuel cell unit (6) is supplied with compressed air that has a pressure of more than 1.5 bar.

4. The apparatus according to one of the preceding claims, characterized in that compressed air coming out of the first heat exchanger (5) is supplied to a first expander (3).

5. The apparatus according to one of the preceding claims, characterized in that the compressed air or compressed exhaust coming out of the fuel cell unit (6) is supplied to the first expander (3).

6. The apparatus according to one of the preceding claims, characterized in that the fuel cell unit (6) is followed by a second heat exchanger (8) in order to cool compressed air or compressed exhaust coming out of the fuel cell unit (6).

7. The apparatus according to one of the preceding claims, characterized in that compressed air or compressed exhaust coming out of the fuel cell unit (6) is supplied to a second expander (7).

8. The apparatus according to one of the preceding claims, characterized in that air coming out of the first expander (3) is supplied to the interior of a vehicle.

9. The apparatus according to one of the preceding claims, characterized in that air coming out of the first expander (3) is supplied to a third heat exchanger (9).

10. The apparatus according to one of the preceding claims, characterized in that the first heat exchanger (5) draws thermal energy out of the compressed air.

11. The apparatus according to one of the preceding claims, characterized in that the first heat exchanger (5) is supplied with a medium to which the thermal energy of the compressed air is imparted.

12. The apparatus according to one of the preceding claims, characterized in that the medium supplied to the first heat exchanger (5) comes from a chamber (4) that is cooled by the cold air process air conditioning unit.

13. The apparatus according to one of the preceding claims, characterized in that the compressor (1) is driven by an electric motor (2).

14. The apparatus according to one of the preceding claims, characterized in that the first expander (3) and/or the second expander (7) recover at least part of the compression work.

15. The apparatus according to one of the preceding claims, characterized in that the compressor (1), the electric motor (2) that drives the compressor (1), and the first expander (3) and/or the second expander (7) can be connected in a positively engaging manner.

16. The apparatus according to one of the preceding claims, characterized in that the compressor (1), the electric motor (2) that drives the compressor (1), and the first expander (3) and/or the second expander (7) are disposed on a common shaft or on shafts coupled by means of transmission mechanisms.

17. The apparatus according to one of the preceding claims, characterized in that the capacity of the compressor (1) and/or of the electric motor (2) that drives the compressor (1) is designed so that it corresponds to or only slightly exceeds the peak capacity required by the fuel cell unit (6).

18. A use of a cold air process air conditioning unit or heat pump as a source for compressed air that is supplied to a fuel cell unit.

19. A use of a compressor, which supplies compressed air to a fuel cell unit, as a source for compressed air that constitutes or is an ingredient of the working medium of an air conditioning unit or heat pump.

20. An apparatus, in particular for a fuel cell-powered vehicle, with a compressor (6), which compresses air that constitutes the working medium of a cold air process air conditioning unit or heat pump, characterized in that at least part of the air compressed by the compressor (1) is supplied to a fuel cell unit (6).

21. The apparatus according to claim 20, characterized in that the cold air process air conditioning unit has a first heat exchanger (5), which is supplied with the portion of air compressed by the compressor (6) that is not supplied to the fuel cell unit (6).

22. The apparatus according to claim 20, characterized in that the fuel cell unit (6) is supplied with compressed air that has a pressure of more than 1.5 bar.

23. The apparatus according to claim 20, characterized in that compressed air coming out of the first heat exchanger (5) is supplied to a first expander (3).

24. The apparatus according to claim 20, characterized in that the compressed air or compressed exhaust coming out of the fuel cell unit (6) is supplied to the first expander (3).

25. The apparatus according to claim 20, characterized in that the fuel cell unit (6) is followed by a second heat exchanger (8) in order to cool compressed air or compressed exhaust coming out of the fuel cell unit (6).

26. The apparatus according to claim 20, characterized in that compressed air or compressed exhaust coming out of the fuel cell unit (6) is supplied to a second expander (7).

27. The apparatus according to claim 20, characterized in that air coming out of the first expander (3) is supplied to the interior of a vehicle.

28. The apparatus according to claim 20, characterized in that air coming out of the first expander (3) is supplied to a third heat exchanger (9).

29. The apparatus according to claim 20, characterized in that the first heat exchanger (5) draws thermal energy out of the compressed air.

30. The apparatus according to claim 20, characterized in that the first heat exchanger (5) is supplied with a medium to which the thermal energy of the compressed air is imparted.

31. The apparatus according to claim 20, characterized in that the medium supplied to the first heat exchanger (5) comes from a chamber (4) that is cooled by the cold air process air conditioning unit.

32. The apparatus according to claim 20, characterized in that the compressor (1) is driven by an electric motor (2).

33. The apparatus according to claim 20, characterized in that the first expander (3) and/or the second expander (7) recover at least part of the compression work.

34. The apparatus according to claim 20, characterized in that the compressor (1), the electric motor (2) that drives the compressor (1), and the first expander (3) and/or the second expander (7) can be connected in a positively engaging manner.

35. The apparatus according to claim 20, characterized in that the compressor (1), the electric motor (2) that drives the compressor (1), and the first expander (3) and/or the second expander (7) are disposed on a common shaft or on shafts coupled by means of transmission mechanisms.

36. The apparatus according to claim 20, characterized in that the capacity of the compressor (1) and/or of the electric motor (2) that drives the compressor (1) is designed so that it corresponds to or only slightly exceeds the peak capacity required by the fuel cell unit (6).

37. A use of a cold air process air conditioning unit or heat pump as a source for compressed air that is supplied to a fuel cell unit.

38. A use of a compressor, which supplies compressed air to a fuel cell unit, as a source for compressed air that constitutes or is an ingredient of the working medium of an air conditioning unit or heat pump.
